(19) United States
(12) Patent Application Publication
(10) Pub. No.: US 2017/0190348 A1
(43) Pub. Date: Jul. 6, 2017

(54) SAFETY APPARATUS AND METHOD FOR AN INFANT CARRIER

(71) Applicant: Ronald Thompson, West Islip, NY (US)

(72) Inventor: Ronald Thompson, West Islip, NY (US)

(21) Appl. No.: 15/256,094

(22) Filed: Sep. 2, 2016

Related U.S. Application Data
(63) Continuation of application No. 62/274,065, filed on Dec. 31, 2015.

(51) Int. Cl. B62B 3/14; A47D 13/02

(52) U.S. Cl. CPC B62B 3/1452; B62B 3/1444; A47D 13/02

(57) ABSTRACT

A safety apparatus for an infant carrier is described that connects to an infant carrier and a shopping cart. The safety apparatus includes a first bar, a second bar and a third bar. The first bar includes a first end portion with a first connector and an opposed second end portion with a second connector. The first connector and second connector are configured to fasten together and unfasten from one another. When the connectors of the first bar are fastened together, the first bar defines a continuous loop. The second bar includes a first end portion that connects to the first bar and a second end portion that includes a third connector. The third bar has the same structure as the second bar. The first bar connects to an infant carrier. The second bar and third bar connect to a shopping cart.

### BACKGROUND OF THE INVENTION

Field of the Invention

The present disclosure relates to the field of a safety apparatus and method for infant carriers and more particularly to an apparatus and method for the safe connection of an infant carrier to a shopping cart.

Description of the Related Art

Devices for retaining infants and children in their seats include a broad array of strap arrangements. These strap arrangements include configurations of straps that directly secure a young child in seats such as high chairs, strollers and vehicular seats. These inventions include strap arrangements configured to strap directly across the chair and infant seated in the chair with the arrangement of straps attaching on either side of the chair. Other inventions include a harness for a child with straps that connect to the seat. Still other inventions involve a strap positioned over the infant in an infant carrier and through apertures in the infant carrier. The strap then connects to an external device on either side of the infant carrier.

These devices are able to connect to most chairs, but are not configured to provide a secure connection between the infant carrier and a movable shopping cart. In particular, traditional connector systems cannot readily connect to the variety of shopping cart ornamental design structures. As a result of these shopping cart structures and in particular, the ornamental design structure of the shopping cart basket sidewalls, traditional connectors are unable to provide a quick and secure child-safe connection. There is a need for an apparatus and a method of use of that apparatus that can securely connect an infant carrier or baby seat to a shopping cart.

A device for safely connecting an infant carrier to all types of shopping carts is needed that can be readily connected and disconnected and securely retain the infant carrier on the shopping cart independent of the ornamental design structure of the shopping cart.

### SUMMARY OF THE INVENTION

A safety apparatus for an infant carrier is described that is adapted to connect between an infant carrier and a shopping cart. The safety apparatus comprises a first bar and a second bar. The first bar has a length that extends between a first end portion to an opposed second end portion. The first end portion and second end portion include mating connectors that fasten together and unfasten from one another. When the connectors of the first bar are fastened together, the first bar defines a continuous loop. The first bar includes an adjustment device that adjusts the length of the first bar or length of the loop defined by the first bar.

The second bar has a length that extends between a first end portion and a second end portion. The first bar and the second bar are flexible straps. Alternatively, the first bar and second bar can be rigid or semi-rigid construction. The first end portion of the second bar is connected to the first bar and the second end portion is a free end. The second end portion includes a connector. The length of the second bar is adjustable.

The safety apparatus for an infant carrier can further include a third bar. The third bar preferably has the same structure as the second bar. The third bar has a length that extends between a first end portion and a second end portion. The first end portion of the third bar is connected to the first bar and the second end portion is a free end. The second end portion includes a connector. The length of the third bar is adjustable.

The first bar of the safety apparatus connects to a handle of the infant carrier and the second bar connects the first bar to the shopping cart. The third bar also connects the first bar to the shopping cart. The first bar, second bar and as required the third bar are adjusted in length to preferably make a taught connection between the shopping cart and infant carrier. The safety apparatus is preferably in tension between the infant carrier and shopping cart so as to retain the infant carrier in position on the child seat.

In a second configuration, the second bar of the safety apparatus for an infant carrier includes a first bar and a second bar. The first bar and the second bar are preferably semi-rigid or rigid structures. The second bar includes a first end portion that includes a first beam and a second end portion that includes a second beam. The first second beam moves relative to the first beam to adjust the length of the second bar. The second beam can be locked in position at a desired length. The first bar of the safety apparatus for an infant carrier defines a first plane, the second bar is aligned transverse to the first plane and the second end portion of the second bar is approximately aligned with the first plane. The connector of the first bar has a first directional orientation and the connector the second bar has an opposing directional orientation.

In a third configuration, the safety apparatus can include the third connector of the second bar and the fourth connector of the third bar each connecting with, one of the fifth connectors of a plurality of fifth connectors. Each of the fifth connectors include the fifth connector on one end and a hook on the opposing end. The hooks of the fifth connectors are adapted to connect to different shopping cart structures that can include, for example, different polymer shopping cart basket sidewalls that vary the size and spacing between apertures defined in the walls of the polymer shopping carts as well as metal wire shopping cart walls. Each fifth connector hook structure for the first configuration comes in sets of four connectors for the two safety apparatus 10 required for operational use. The second configuration requires a set of two connectors for the two safety apparatus 10 required for operational use.

A method of using a safety apparatus for an infant carrier includes the steps of providing an infant carrier, a shopping cart and a safety apparatus for an infant carrier. The safety apparatus for an infant carrier is used to fixedly connect the infant carrier in position on the shopping cart. In this one preferred configuration, the safety apparatus for an infant carrier comprises two or more safety apparatuses for each infant carrier. As described in the first configuration, the safety apparatus for an infant carrier or safety apparatus includes a first bar, a second bar and a third bar. The safety apparatus provided in the method includes a first bar, a second bar and an optional third bar as described previously.

The method of using a safety apparatus includes placing a wheeled shopping cart in a stable position at a fixed or an approximately fixed location. A stable position as defined herein includes positioning the movable shopping cart such that the shopping cart will not unduly move, drift or roll before, during or after the positioning on and connecting of the infant carrier to the shopping cart using the safety apparatus.

The stable position preferably includes positioning the shopping cart on an approximately level surface such that the shopping cart is at rest and not moving. Alternatively, if available, the shopping cart may have a brake to lock one or more wheels of the shopping cart or chock one or more wheels to prevent undesirable rolling. The stable position can also include, as another alternative or in addition to the above, positioning one hand on the infant carrier in a first position, with the infant carrier resting on and between the rear sidewall and the foldable seat in the open position. By positioning one hand on the infant and/or shopping cart, the shopping cart can be maintained in the stable position while using the safety apparatus to connect the infant carrier to the shopping cart.

The method includes fastening the first and second connectors of the first bar around a handle on a first side of the infant carrier. The length of the first bar is adjusted to provide a secure and tight connection to the handle of the infant carrier. The first bar is positioned on the handle in proximity to the body of the infant carrier.

The method includes fastening the second and third bars of the safety apparatus to the shopping cart. The third connector of the second bar is fastened to the shopping cart by locking a portion of the shopping cart in the third connector. The third and fourth connectors can be any suitable connector that can connect to the shopping cart and provide the level of security and safety required for infant applicants. The third and fourth connectors define openings that are approximately at least one inch between the opposing ends of their respective connectors and approximately one inch between the opening and the back of their respective connectors. The third connector and fourth connector each receive and securely close around a portion of the shopping cart. The portion of the shopping cart can be a wire or other structure such as a strip of material that defines the perforated shopping cart basket sidewalls, for example. The lengths of the second bar and third bar are adjusted to secure a tight connection of the safety apparatus for an infant carrier between the first bar around the handle of the infant carrier and the shopping cart.

The method also includes fastening a second safety apparatus around the handle on a second side of the infant carrier in proximity to the body of the infant carrier. The second safety apparatus is fastened between the infant carrier and the shopping cart as described above for the first side and includes fastening the connectors of the first bar of the second safety apparatus for an infant carrier around the handle on the opposing second side of the infant carrier in proximity to the body of the infant carrier. The length of the first bar can be adjusted using the adjustment device to make a tight connection to the handle of the infant carrier. The second bar and third bar are preferably connected to the opposing second side of the shopping cart in the same manner as described above for the first safety apparatus. The length of the second bar and third bar is adjusted to secure a tight connection of the safety apparatus between the handle on the opposing side of the infant carrier and the opposing side of the shopping cart from the first safety apparatus as described previously.

Another method of connecting a safety apparatus for an infant carrier to an infant carrier on a shopping cart includes the steps of providing an infant carrier, a shopping cart and a safety apparatus for an infant carrier. The safety apparatus for an infant carrier comprises a first bar and a second bar. The first bar includes a first end portion and an opposed second end portion. The first end portion and the second end portion of the first bar include connectors. The connectors are configured to fasten together and unfasten. The first bar includes an adjustment device that adjusts the length of the first bar. When the connectors of the first bar are fastened, the first bar defines a continuous loop. The second bar includes a first end portion and a second end portion. The first end portion is connected to the first bar and the second end portion is a free end that includes a connector. The length of the second bar is adjustable.

The method includes fastening the connectors of the first bar to a handle of the infant carrier in proximity to a body of a first side of the infant carrier and adjusting the length of the first bar to secure a tight connection to the handle. The first bar is securely positioned around the handle and in proximity to a first side of the body of the infant carrier. The tight connection of the first bar as defined herein is the first bar placing the handle in compression. The method includes fastening the connector of the second bar of the safety apparatus for an infant carrier to the shopping cart and adjusting the length of the second bar to secure a tight connection of the safety apparatus for an infant carrier between the handle of the infant carrier and the shopping cart. The method includes fastening a connector of the first bar of a second safety apparatus for an infant carrier to the handle of the infant carrier in proximity to the opposing or second side of the body of the infant carrier and adjusting the length of the second bar to secure a tight connection of the safety apparatus for an infant carrier between the opposing handle of the infant carrier and the opposing side of the shopping cart. The tension or tight connection of the second bar between infant carrier and the shopping cart as defined herein means the second and third bar are placed in tension between the first bar connected to the infant carrier and the shopping cart. Tension as defined herein means that the second bar and third bar are taught between the connection of the first bar and infant carrier and the shopping cart such that the infant carrier is immobilized and/or fixed in position on the shopping cart.

### BRIEF DESCRIPTION OF THE DRAWINGS

FIG. 1 is a front and top perspective view of the safety apparatus for an infant carrier as described in the present disclosure;

FIG. 2 is a front and top perspective view of a second configuration of the safety apparatus for an infant carrier of FIG. 1;

FIG. 3 is a side view of the second configuration of the safety apparatus for an infant carrier of FIG. 2;

FIG. 4 is a front, side and top perspective view of the operational use of the safety apparatus for an infant carrier of FIG. 1 connected to an exemplary infant carrier and an exemplary shopping cart;

FIG. 5. is a front, side and top perspective view of the connection of the safety apparatus for an infant carrier of FIG. 2 connected to the infant carrier and the shopping cart;

FIG. 6 is a side perspective close-up view of a portion of a polymer sidewall of a basket of an exemplary shopping cart showing one preferred embodiment of the safety apparatus for an infant carrier of FIG. 1 connected to the shopping cart; and

FIG. 7 is a front and top perspective view of the safety apparatus for an infant carrier of FIG. 1 as a kit, the kit includes sets of alternative structures of hooks.

### DETAILED DESCRIPTION OF THE INVENTION

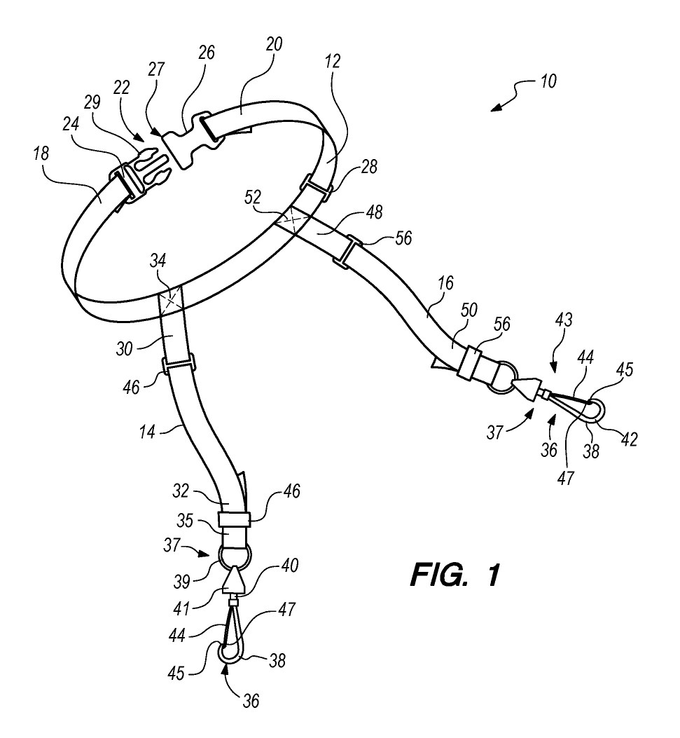

Referring, initially to FIG. 1, a safety apparatus for an infant carrier 10 in a first configuration includes a first bar 12, a second bar 14 and an optional third bar 16. The second bar 14 and third bar 16 connect to first bar 12. First bar 12, second bar 14 and third bar 16 of safety apparatus for an infant carrier 10 or safety apparatus 10 are preferably flexible bars or bands of material suitable for use in securing the safety apparatus for an infant carrier 10 to an external device.

First bar 12 has a first end portion 18 and an opposed second end portion 20. First bar 12 has a length that extends between first end portion 18 and second end portion 20. A fastener 22 includes a first connector 24 attached to first end portion 18 and a second connector 26 that is attached to second end portion 20. First connector 24 and second connector 26 mate together to form an at least secure and child resistant fastener 22. First bar 12 also includes an adjustment device 28.

First connecter 24 and second connector 26 are securely connected to first bar 12 by means of a safety connection that is a suitable load bearing connection for an infant carrier and infant. The standard means of connection can include one or more of sewn, heat, adhesives and mechanical means such as but not limited to brads, staples or studs. The connection of first bar 12 to first connector 24 and second connector 26 provides a suitable safety factor for the applications described herein.

In this one preferred embodiment, first connector 24 is a male connector and second connector 26 is a female connector. First connector 24 includes two or more flexible cantilever flexible prongs 29 that are biased to a first position. When mating with second connector 26, first connector 24 prongs 29 flex inwardly in aperture 27 of second connector 26 from the first position to a second deflected position. Aperture 27 is tapered in the initial portion of connector 26 and then expands a second portion so as to define a locking mechanism for prongs 29. The second portion of second connector 26 defines secondary apertures transverse to aperture 27 that accommodate the outwardly directed bias of prongs 29 to the first position which securely locks first connector 24 and second connector 26 together.

To disconnector fastener 22, both prongs 29 of first connector 24 have to be simultaneously depressed inward from the first position locked in connector 26 and first connector 24 has to be simultaneously moved relative to second connector 26 such that prongs 29 are at least partially compressed and in the first tapered portion of aperture 27 of second connector 26. Alternative fastener 22 configurations, for example, require the simultaneous pressing of two buttons on second connector 26 that deflect the one or more cantilevered prongs of first connector 24 from the locked position in second connector 26 to disengage the locking mechanism of fastener 22 along with the relative movement of first connector 24 relative to second connector 26. First connector 24 is then fully disconnected with second connector 26 by the withdrawing of first connector 24 through aperture 27 of second connector 26.

First bar 12 adjustment device 28 provides the ability to increase or decrease the overall length of first bar 12. Adjustment means or adjustment device 28 is connected to first bar 12 and can be a stand-alone adjustment device 28 or an additional structural component of first fastener 22 that can readily adjust the overall length of the first bar 12. In this one preferred embodiment, adjustment device 28 is part of first connector 24 and/or second connector 26 of fastener 22. The length in this one configuration of first bar 12 can be adjusted by drawing a portion of first bar 12 through first connector 24 and/or second connector 26 to define the desired overall length of first bar 12. Adjustment device 28 can include a locking mechanism that secures and, fixes the length of first bar 12 at a given desired length. It is understood that adjustment device 28 can take any structural form that functions to adjust the length and securely engage with, lock and fix the length first bar 12 at the desired adjusted length. In one preferred embodiment, first bar 12 has a minimum, adjustable length between first connector 24 and second connector 26 of approximately one (1) inch, a preferred initial length of approximately six (6) inches and a preferred maximum adjustable length of approximately eleven (11) inches.

Alternatively, an idealized depiction of adjustment device 28 as a separate device is shown located on first bar 12. Adjustment device 28 can define a secondary adjustment loop that includes a movable first connector 24 and/or second connector 26 within the adjustment loop that can adjust the overall length of first bar 12. In this configuration, first connector 24, for example, is free to slide along the variable length of adjustment loop to define the desired overall length of first bar 12.

First bar 12 has a first position in which first connector 24 and second connector 26 are disconnected and a second position in which first connector 24 and second connector 26 are connected. In the second position first bar 12 defines a flexible loop with a variable shape. The length of first bar 12 can be adjusted in both the first, position and the second position.

Second bar 14 has a first end portion 30 and an opposed second end portion 32. First end portion 30 includes a connection 34 to first bar 12 and second end portion includes a connection 35 to a connector 36. Second bar 14 includes the ability to adjust the length of second bar 14 using connection 34, connection 35 and/or a separate adjustment device 46 as described earlier for adjustment device 28 of first bar 12. Second bar 14 has a preferred initial length of approximately sixteen (16) inches and preferred maximum length of approximately twenty-four (24) inches.

Second bar 14 first end portion 30 preferably has fixed connection 34 with first bar 12, but it is understood that connection 34 can include the ability to adjust and securely lock the location of connection 34 on first bar 12. The first end portion 30 connection 34 of second bar 14 with first bar 12 is preferably as described previously for the connection between first connector 24 and first bar 12. Second end portion 32 is preferably a free end that connects to a connector 36. Second end portion 32 preferably has a fixed connection 35 to connector 36. Connection 35 of second end portion 32 can include the ability to attach two or more connectors 36 as described above for first connector 24 and second connector 26. Connection 35 can fix each of the two or more connectors 36 at a location on second bar 14 or the two or more connectors 36 can be independently movable along a loop defined by connection 35, for example. Alternatively, connection 35 can enable connector 36 to be attached, reattached, connected and/or disconnected to provide the capability to select one or more connectors 36 for second end portion 32.

Connector 36 includes a proximal end portion 37 and a hook 38. Proximal end portion 37 includes one or more structures that facilitate the movement of hook 38. Hook 38 provides connectivity to external structures. Connector 36 is structured to provide a secure safety connection that is easily connected to and disconnected from external structures. Connector 36 is a child proof connector.

In one preferred embodiment, connector 36 proximal end portion 37 includes a structure for the independent movement of connector 36 relative to second bar 14. Proximal end portion 37 preferably includes a ring 39 and a bracket 41. Ring 39 connects to second bar 14 second end portion 32 and ring 39 connects to bracket 41. The connection between ring 39 and second end portion 32 of second bar 16 can include movements such, as sliding, pivoting and/or axial rotation of ring 39 relative to second portion 32.

Proximal end portion 37 ring 39 preferably accommodates the arcuate movement of bracket 41 along the annular structure of ring 39. Bracket 41 can be fixedly connected or movably connected to hook 38. Bracket 41 preferably accommodates relative axial rotation of hook 38 relative to bracket 41. The connection between proximal end portion 37 and hook 38 preferably includes at least the relative axial rotation of hook 38.

Hook 38 is an elongate shaft that includes, a proximal end portion 40, a central portion and a distal end portion 42. The proximal end portion 40, central portion and distal end portion 42 are preferably aligned in a plane. Proximal end portion 40 connects to bracket 41 of proximal end portion 37 of connector 36. Distal end portion 42 of hook 38 defines a hook shape that can be arcuate and/or angular in shape. Hook 38 defines an opening 43 that is closed by a gate 44. The elongate length of opening 43 is defined between proximal end portion 40 and a distal end 45 of second end portion 42. Opening 43 and gate 44 are preferably aligned with the plane defined by hook 38.

Gate 44 connects to proximal end portion 40 on a first end and has an opposed free end or terminal end 47. Gate 44 extends across opening 43. Gate 44 distal end 47 is preferably in close proximity to or direct contact with a distal end 45 of distal end portion 42 of hook 38. Gate 44 is movable to open and close opening 43. The movement of gate 44 can be any type of movement, but preferably includes a hinged, pivot, flexible, biased and/or sliding connection with proximal end portion 40 of hook 38. Gate 44 is preferably a bias member that flexes at the connection with proximal end 40 to define opening 43 between gate 44 distal end 47 and distal end 45 of distal end portion 42. Gate 44 is preferably biased to return to a closed position and, securely close opening 43. Gate 44 can also include a locking mechanism that secures gate 44 in the closed position.

In this preferred embodiment, proximal end portion 40 of hook 38 is contiguous with the central portion of hook 38 and is in fixed spaced separation with opening 43. The central portion of hook 38 can be straight, angular and/or arcuate. Hook 38 defines an area between gate 44, proximal end portion 40, the central portion and distal end portion 42 that can receive and retain external objects. Distal end portion 42 as defined herein can include straight and/or arcuate shapes.

Proximal end portion 40 of hook 38 in the preferred embodiment of a clip type connector 36 includes a first portion that is connected to the angled and/or arcuate central portion of hook 38. The hook shape of distal end portion 42 ends at a terminal end 45 that is turned approximately one hundred eighty degrees (180 degrees) from the initial alignment of proximal end portion 40. The hook shape of hook 38 defines a plane. Terminal end 45 of arcuate portion 42 of hook 38 is preferably approximately parallel to the proximal end portion or shaft 40 of hook 38.

In the preferred embodiment, the distance of the length of opening or gap 43 between proximal end portion 40 and distal end 45 is at least approximately one inch (1). The preferred embodiment also includes hook 38 second end portion 42 radius or height of at least approximately five-eighths (⅝) inch from the inner side of the distal peak of the arc of the hook to terminal end 45 of distal end portion 42 of hook 38. The preferred approximate size or depth of opening 43 between distal end 45 and the opposing central portion of hook 38 is at least approximately one-half (½) inch; this is also the approximate maximum flexible displacement of gate 44 for the clip type connector 36.

Gate 44 is a cantilever beam that connects to the first portion of the proximal end portion 40 of hook 38 on one end and extends distally with gate 44 distal end 47 positioned in contact with, extending beyond and/or in close proximity to terminal end 45 of second end portion 42 of hook 38. Gate 44 terminal end 47 is biased towards the inward facing inner side of the terminal end 45. Gate 44 is biased to position terminal end 47 in close proximity or direct contact with terminal end 45 of distal end portion 42 to securely close hook 38.

Connector 36 is a childproof connector that can securely fasten to external structures such as an array of relatively thin metal wires as well as wider and thicker polymer strips in the form of a lattice, grid, grate or mesh, for example. It is, understood that connector 36 can have many structural shapes and alternative gate 44 structures. For example, the while the overall structure of hook 38 as described above is that of a clip type connector 36, hook 38 can be a friction clip, snap bias clip or a carabiner type connector 36 that meets the requirements defined herein. Each connector type, has advantages for connecting to different types of external structures. The structure of a bias clip includes a hook 38 and a bias element 44.

Connector 36 can further include a lock, locking mechanism or secondary safety mechanism that secures connector 36 in the closed position. Connectors 36 can also have separate connections 35 to a split second end portion 32 of second bar 14 or, for example, connectors 36 can have bracket 43 connect to two or more hooks 38. Connection 35 between connector 36 and second bar 14 can also be non-fixed and accommodate the attachment and/or removal of different hooks 38 to second bar 14 as described above.

The bias clip connector 36 described above is suited to connect to external structures that range from relatively small thickness or diameters such as metal wires to perforated polymer walls or polymer lattices or grids that define apertures. The hook 38 depth and length, of opening 43 of bias clips and snap type connectors 36 that define larger sized lengths and depths of opening 43, however, can accommodate external structures with larger thickness, diameters and/or perforated wall structures with varying distances between perforations or apertures. In one example, a bias clip with an approximately one (1) inch wide opening 43 and approximately five-eighths (⅝) hook depth can accommodate a sizable range of external structure thicknesses and/or distances between apertures that exceed one-half (½) inch.

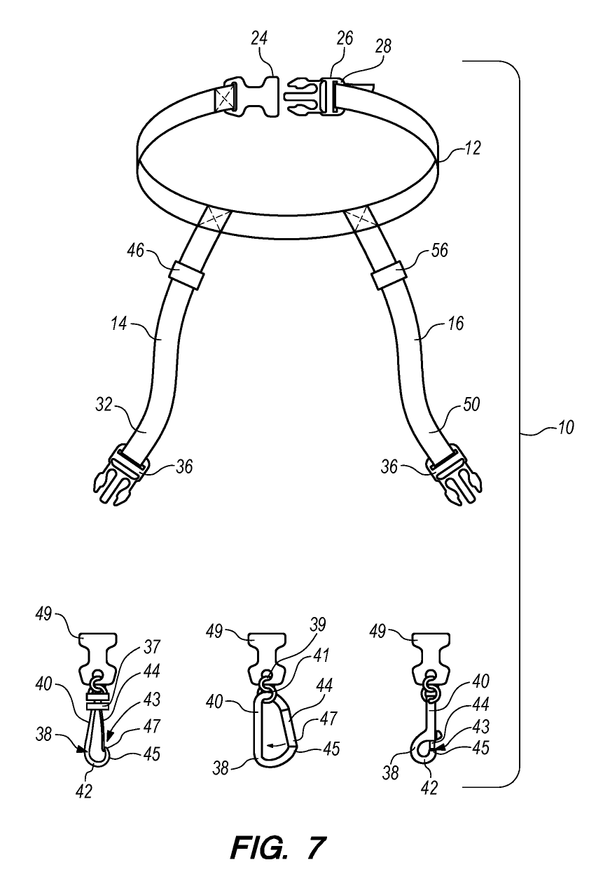

As one example, a carabiner clip or C-clip hook 38 structure typically has an angular overall approximately C shape that defines an opening between the ends of the C (See FIG. 7). In this configuration of hook 38, gate 44 is preferably biased to connect to and biased against the opposing distal end 45 of the C shape. Gate 44 can also include a secondary safety mechanism that secures gate 44 in the closed position. The secondary safety mechanism can include any means of securing the closure of hook 38 to include an elongate threaded nut or sleeve positionable over the distal end 47 of gate 44 or a bias snap, for example. The structural arrangement of connector 36 preferably includes a secure connection that is at least a bias to the closed position of gate 44 with the distal end portion 42 of hook 38.

The gap or opening 43 of the carabiner configuration of hook 38 is defined as the distance between the ends of the ends of the C shaped carabiner hook 38 of connector 36 is preferably at least approximately one (1) cinch. In the preferred embodiment, carabiner hook 38 defines a depth of opening or the distance between gate 44 and the opposing central portion or back of hook 38 of approximately one (1) inch. Gate 44 is preferably biased to the closed position. Second bar 14 also includes an adjustment means or device 46 as described above for first bar 12 to adjust the length of second bar 14.

Third bar 16 is included in this preferred embodiment of safety apparatus 10. Third bar 16 has a structure that is identical to second bar 14. Third bar 16 includes a first end portion 48 and an opposed second end portion 50. First end portion 48 is preferably connected to first bar 12 and second end portion 50 is preferably a free end. First end portion 48 includes a connection 52 to first bar 12. First end portion 48 preferably has fixed connection with bar 12, but the connection between first end portion 48 and bar 12 can include the ability of first end portion 48 to adjustably slide along bar 12. Second end portion 50 includes a connection 52 to connector 36. Connector 36 includes proximal end portion 37 and hook 38 as described previously for connector 36 of second bar 14. Third bar 16 also includes an adjustment means or device 56 that can be a portion of connectors 36 or a separate assembly as described above for adjustment device 46 of second bar 14.

First bar 12, second bar 14 and third bar 16 are preferably flexible bands or strips made of one or more of cotton, rubber, composite materials, metals and/or polymers that can further include reinforcing for this safety application. First bar 12, second bar 14 and third bar 16 preferably do not stretch along their elongate axes. Safety apparatus 10 includes adjustment devices 28, 46 and 56 for the adjustment of the length of first bar 12, second bar 14 and third bar 16, respectively. First bar 12, second bar 14 and optional third bar 16 can be flexible, semi-rigid, or rigid portions depending upon the desired application. In this exemplary depiction, first bar 12, second bar 14 and optional third bar 16 have elongate flexible shapes.

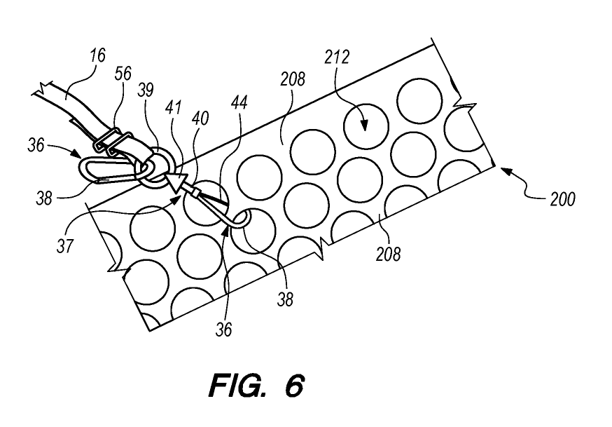

As shown in FIGS. 1, 6 and 7, safety apparatus 10 in this preferred configuration includes second end portion 32 of second bar 14 and second end portion 50 of third bar 16 with connectors 36 that are preferably the same as second connectors 26 of first fastener 22. Connectors 49 are preferably the same as first connectors 24 of first fastener 22 and corresponding mate with connector 36.

Connectors 49 have the mating connector 49 for connector 36 on one end and on the opposing end one or more of the different structures of hook 38 on the opposing end. Connectors 49 and hooks 38 provide a secure child-proof and reliable connection.

Each connector 49 is attached to one or more configurations of hooks 38 such as, but are not limited to, clip type, bias, carabiner or C-clip and bolt snap type connectors as described and/or shown herein. Connectors 36 and 49 can include a secondary safety mechanism to preclude premature release as described previously.

The connection between connector 49 and hook 38 can vary depending upon the intended application of safety apparatus 10, but preferably includes a ring 39 and bracket 41 as described previously for connector 36. In this embodiment, as an exemplary alternative both ring 39 and bracket 41 can have a ring structure that provides for the independent movement of hook 38 relative to connector 49.

Each connector 49 and hook 38 configuration can vary besides the overall structure of hook 38 such as, for example the length of opening 43 and depth of openings 43. Connector 49 hooks 38 preferably include at least one bias clip hook 38 that has the same basic structure as described previously for the first configuration of hook 38 connectors 36 of second bar 14 and third bar 16.

The different structure of hooks 38 of connectors 49 are configured to be able to connect to different shopping cart structures 200. The different shopping cart structures 200 can include, for example but not limited to, different polymer shopping cart baskets 210 that include walls that define apertures 212 that vary in their sizes in the basket 210 walls, the spacing between apertures 212 in the basket 210 walls as well as metal wire shopping cart basket 210 walls. These variable distances, the width of the opening and depth of the opening of hooks 38 connectors 36 and/or connectors 49 define a critical ability of the opening of hook 38 to receive a portion of a shopping cart 200. Connectors 49 are preferably provided in two (2) matching sets of two (2) identical structures of hooks 38 for second bar 14 and third bar 16 of the first and second safety apparatus 10. In the second configuration, connectors 49 are preferably provided in two (2) identical structures of hooks 38 for second bar 14 for the first and second safety apparatus 10.

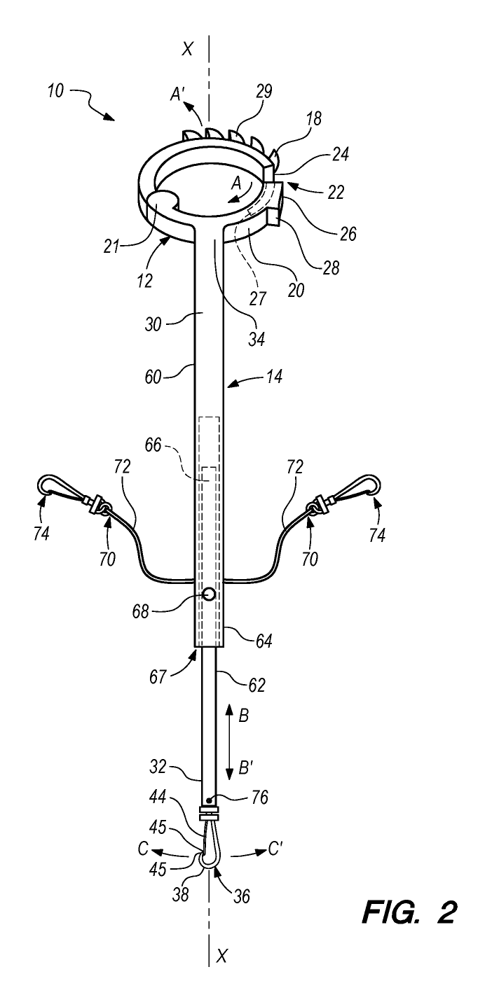

Referring now to FIG. 2, in a second embodiment of the present disclosure, safety apparatus 10 includes first bar 12 and second bar 14. First bar 12 and second bar 14 are connected. First bar 12 and second bar 14 are preferably rigid or semi-rigid structures. Safety apparatus 10 can also include optional third bar 16 that is connected to first bar 12.

First bar 12 includes first end portion 18 and opposed second end portion 20. First bar 12 first end portion 18 and second end portion 20 preferably have arcuate shapes. First bar 12 includes a connection 21 that accommodates the independent movement of first end, portion 18 and/or second end portion 20. Connection 21 is preferably a single hinge or pivot type connection, but can include multiple hinges and/or sliding that can accommodate more complex movements. The movement of first end portion 18 relative to second end portion 20 can include, for example, the rotational movements about connection 21 as shown in the directions of arrows A and A′. First bar 12 defines a first plane. The movement of the first end portion 18 and second end portion about connector 21 is preferably in the first plane.

First bar 12 includes first fastener 22 that connects the preferably arcuate shapes of first end portion 18 and second end portion 20 together. First bar 12 has an open position with first fastener 22 unconnected and a closed position with first fastener 22 connected. In the closed position, first bar 12 defines a closed loop shape. First fastener 22 or fastener 22 is a child proof and/or child resistant safety fastener.

First fastener 22 includes first connector 24 and second connector 26. A distal end of first end portion 18 preferably includes first connector 24 and a distal end of second end portion 20 preferably includes second connector 26. First connector 24 is configured to securely connect with second connector 24. First bar 12 preferably has an arcuate approximately circular shape when fastener 22 first connector 22 and second connector 24 are connected. The length of first bar 12 can adjusted by an adjustment device that can be, in one illustrative configuration for example, first connector 24 and second connector 26 providing the ability to selectively adjust where second connector 26 engages and locks with first connector 24 and/or first end portion 18. For example, by connecting closer or further from connection 21 on first connector 24, second connector 26 can adjust the length of the overall perimeter of the loop defined by first bar 12. It is understood that the structure of first connector 24 and second connector 26 can take any form that provides a child safe security connection for first bar 12.

In one preferred embodiment of fastener 22, first connector 24 is sized and dimensioned to be received into an aperture 27 defined in second connector 26. Aperture 27 is preferably aligned with the arcuate axis defined by second end portion 20. Aperture 27 preferably extends a predefined distance in second connector 26 and/or second end portion 20. In the closed position of first bar 12, the length of the loop defined by first bar 12 is adjustable by the length of first connector 22 that is inserted into second connector 24. The length, of aperture 27 in second end portion 20 can accommodate an extended length of first connector 24 and/or first end portion 18. Fastener 22 accommodates the selective fixing of the position of first connector 24 and/or first end portion 18 received by second connector 26 and/or second end portion 20 at a desired position to securely lock the length of first bar 12 for, a desired application.

Continuing with the preferred configuration of fastener 22, first connector 24 includes a plurality of teeth 29 and aperture 27 of second connector 26 can include a structure to engage with and securely connect with teeth 29 such as, but not limited to a mating set of teeth. The engagement of teeth 29 with second connector 26 provides a secure connection between first end portion 18 and second end portion 20. The plurality of teeth 29 extend a pre-defined length along first connecter 24 such that the engagement of teeth 29 with second connector 26 can vary the length of first bar 12. This adjustment means or ability to adjust the length of first bar 12 is an integral part of first fastener 22. It is understood that teeth 29 provide a mating interface with second connector 26 and the location of teeth 29 on first connector 24 and the corresponding mating interface of second connector 26 can vary and still provide the required child proof locking interface of fastener 22.

Continuing with the second embodiment of safety apparatus 10, second bar 14 has a first end portion 30 and an opposed second end portion 32. First end portion 30 includes a connection 34 to bar 12 that can be any type of connection to include a ball and joint, hinged, etc., but is a fixed connection in this one preferred embodiment. Second end portion 32 is a free end. Second end portion 32 includes connector 36. Connector 36 preferably includes proximal end portion 37 and hook 38 as described previously for the first configuration.

Second bar 14 preferably has a fixed angle transverse to the first plane defined by first bar 12. As shown in this preferred embodiment, an elongate axis-X extends through second bar 14 and the plane defined by first bar 12.

Second bar 14 in the second preferred embodiment has an adjustable length along axis-X that includes a first beam 60 and a second beam 62. First beam 60 includes first end portion 30 of second bar 14 and terminates in a distal end portion 64. Second beam 62 includes a proximal end portion 66 and second end portion 32 of bar 14. Second beam 62 is movable along longitudinal axis-X in the direction of arrows B and B′.

The length of second bar 14 can be adjusted by the connection between second beam 62 and first beam 60. In one preferred configuration of second bar 14, second beam 62 is slidingly engaged with distal end portion 64. First beam 60 connects with second, beam 62 and accommodates the movement of second beam 62 relative to first beam 60. In this one preferred embodiment, the length of second bar 14 is adjusted by the sliding movement of second beam 62 relative to first beam 60 along longitudinal axis-X.

Continuing with the preferred embodiment of second beam 14, first beam 60 is an elongate bar with a fixed length. An aperture 67 is preferably defined in the distal end portion 64 of first beam 60 that receives the proximal end portion 66 of second beam 62 to accommodate the relative movement of second beam 62. Aperture 67 is elongate opening of predefined length in distal end portion 64 of first beam 60. Aperture 67 is preferably aligned with axis-X. The adjustable length interface between first beam 60 and second beam 62 can be any kind of connection to include those described above that provide a suitable structural integrity and security for use in child restraint applications. For example, aperture 67 can be a channel or hole defined in first beam 60 that defines a telescoping type interface. Similarly, first beam 60 can include annular shaped extensions external to the surface of first beam 60 that define aperture 67 and receive second beam 62. The interface of second beam 62 in aperture 67 can further include, but is not limited to devices such as a sliding, ratchet, threaded, friction or toothed interface between distal end portion 64 and proximal end portion 66. Second beam 62 can any type of structure that interfaces with aperture 67 for the adjustment of the length of second bar 14.

The locking mechanism of second bar 14 provides a safe and secure connection between first beam 60 and second beam 62 for uses associated with infant or child safety. The locking mechanism engages and secures the position of second beam 62 at selectable length relative to first beam 62. The locking mechanism includes an actuator 68 that can be used to lock and release the locking mechanism that secures the connection and relative positions of first beam 62 and second beam 64.

Second bar 14 can have one or more secondary connectors 70. Each secondary connector 70 includes a flexible portion 72 and connector 74. The flexible portion 72 connects to second bar 14 and connector 74. In the preferred embodiment, the flexible portion 72 connects to or in proximity to distal end portion 64. The flexible portion 72 allows, for the movement of connector 74 relative to second bar 14. Connector 74 is preferably one of the structures of hook 38 previously described herein. In the preferred embodiment there two secondary connectors 70 that are connected to and extend from approximately opposing sides of second bar 14.

Second end portion 32 connector 36 preferably has a fixed angular orientation that is preferably approximately aligned with the first plane of first bar 12 and preferably transverse to the alignment of second bar 14 first beam 60 and proximal end portion 66 of second beam 62. Second end portion 32 can further include a joint 76 that accommodates the transverse movement of connector 36 relative to second bar 14 axis-X as shown by arrows C-C′ and/or the rotation about axis-X. The movement along arrows C-C′ can be in any direction such as limited to only one plane by a hinge joint 76, for example, or any direction by a ball joint, for example. Utilizing joint 76, connector 36 can move from aligned with longitudinal axis-X to an angle that is in excess of ninety degrees (90°).

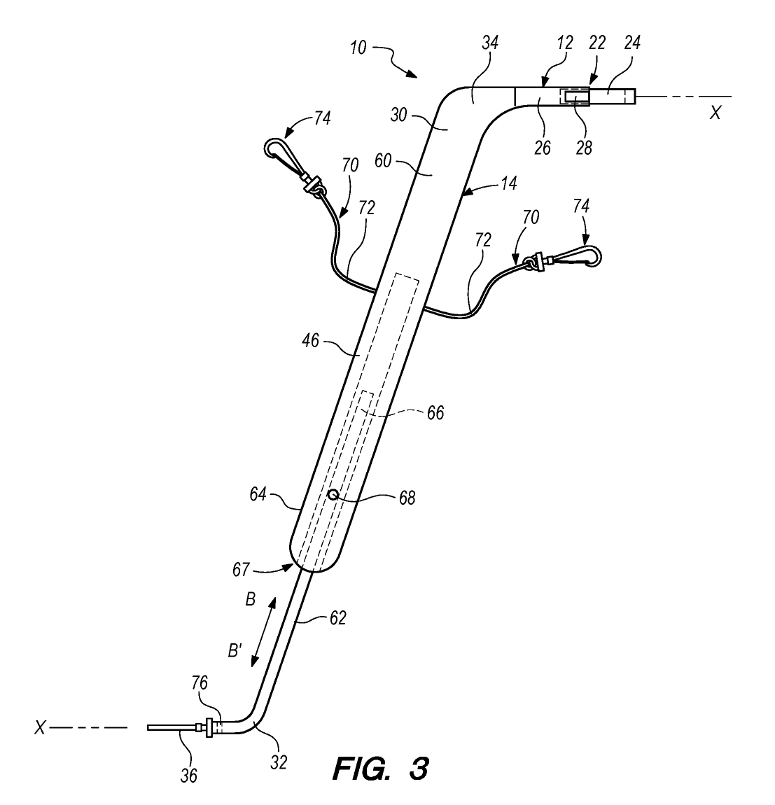

As shown in FIGS. 2 and 3, in this preferred embodiment second bar 14 is angled approximately thirty degrees (30°) from a perpendicular to the first plane defined by first bar 12. Distal end portion 32 can also be angled from second bar 14 to an alignment that is approximately parallel to the first plane as described above. Second beam 62 can be extended and/or retracted along the longitudinal axis-X and is movable in the direction of arrows B and B′. Joint 36 can also be a hinge and connector 36 moves in a plane approximately parallel to the plane defined by first bar 12. It is understood however that, joint 76 can be any kind of movement between connector 36 and second end portion 32.

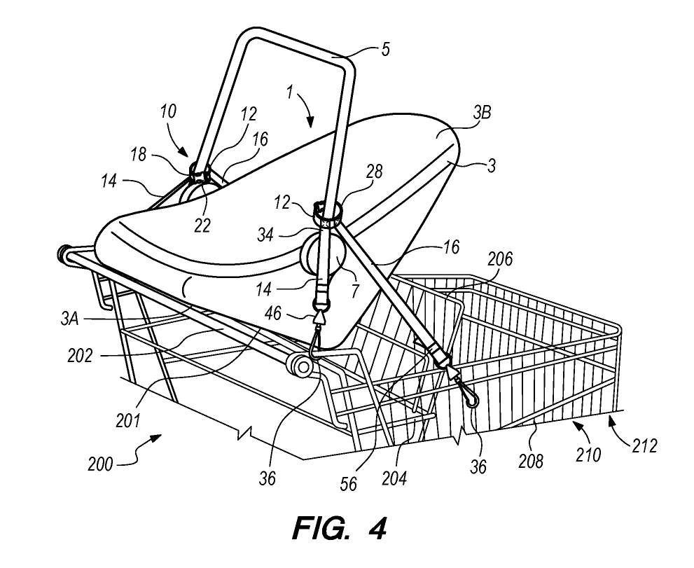

Referring now to FIGS. 1, 4 and 6, the first embodiment of safety apparatus for an infant carrier 10 in operation includes the positioning of an infant carrier 1 onto a shopping cart 200 and safety apparatus 10 is used to connect and fix infant carrier 1 in position on shopping cart 200.

Infant carrier 1 includes a shell 3 and a carrying handle 5. Shell 3 has a general L shape with a seat 3A and a back 3B fixed relative to one another. Shell 3 can have a shape that is angular, arcuate or a combination thereof. Shell 3 typically provides a receptacle for an infant. Handle 5 includes an adjustment device 7 that is connected to shell 3 that adjusts the angle of handle 5 relative to shell 3. Handle adjustment device 7 can lock handle 5 in a position until handle adjustment device 7 is again actuated to rotate handle 5 relative to shell 3. Handle adjustment device 7 can be located on handle 5, positioned on shell 3 or a combination thereof. Handle 5 is positioned in a vertical alignment and/or vertical alignment relative to shopping cart 200. Safety apparatus 10 provides a secure connection between infant carrier 1 and shopping cart 200. The infant carrier 1 shell 3 is configured to receive an infant at an inclined position.

Infant carrier 1 is described herein in use with a shopping cart 200. Shopping cart 200 includes a rear sidewall 201, handle bar 202, a foldable child seat 204, a basket 210 and wheels for movement. It is understood, however, that the method of using safety apparatus 10 can be applied to other structures of shopping carts 200 in which it is desirable for a user to position and connect infant carrier 1 using safety apparatus 10. Shopping carts 200 can vary in their size, materials of construction, structure and ornamental design of the various structural components of shopping cart 200. For example, depending upon the configuration of shopping cart 200, handle bar 202 can be included as a part of rear sidewall 201 or handle bar 202 can be located proximal to and in fixed spaced separation from rear sidewall 201. As defined herein, rear sidewall 201 of shopping cart 200 includes handle bar 202. It is understood that the individual designs of the different shopping carts 200 vary. It is understood that in, reference to shopping cart 200, a distal direction is towards the front of shopping cart 200 and the proximal direction is towards rear sidewall 201.

Shopping carts 200 are constructed of a wide variety of materials that include, but are not limited to metals and/or polymers. Traditional shopping carts 200 typically have baskets 210 that include four sidewalls and a bottom made of metal wires 208. The sidewalls, as defined herein include a front sidewall and a rear sidewall 201 connected by a first lateral sidewall and an opposing second lateral sidewall. While traditional shopping carts 200 have baskets 210 fabricated of metal wires 208, shopping carts 200 and in particular shopping basket 210 sidewalls and bottoms are increasingly made of polymers as well as metals.

As defined herein, each wire 208 is a portion of shopping cart 200 that can include metal wires as well as strips of other materials such as polymers and composites. Metal wires 208 define a porous sidewall and bottom of shopping basket 210 structure that includes a plurality of apertures or gaps 212. The specific shape of, separation between and arrangement of apertures 212 in baskets 210 is dependent upon the ornamental design of the particular basket 210 of shopping cart 200. For example, wires 208 can vary in their length, width, thickness, cross-sectional shape, separation between wires 208 and separation between intersections of wires 208. Similarly, wires 208 can define any type of porous bottom and sidewall structure of basket 210 to include, but not limited to, a lattice, grid or grate structure of shopping basket 210. Wires 208 of baskets 210 can also be walls that are the sidewalls and bottom of shopping basket 210 that define a plurality of perforations.

Similarly, the ornamental arrangement of apertures 212 defined by wires 208 can be any arrangement or design to include a uniform or non-uniform arrangement, for example that can vary the size and number of apertures 212 between wires 208. Wires 208 are located in fixed spaced separation to define apertures 212 and the porous sidewall structures of basket 210. As defined herein, basket 210 also includes seat 204.

Foldable child seat 204 includes a seat and a back 206 that are typically connected to rear sidewall 201 of basket 210. The seat and back 206 have a folded position and an open position. Back 206 typically has an, upper edge that is approximately the same height as handle bar 202 and/or rear sidewall 201 and back 206 is typically connected at or in proximity to the connection of rear sidewall 201 and the bottom of basket 210 of shopping cart 200. Child seat 204 also includes a sliding and/or hinged connected between rear sidewall 201 and back 206.

In the folded position of child seat 204, the seat and back 206 of child seat 204 are typically positioned flat against rear sidewall 201 of basket 210 or the proximal portion of shopping cart 200 in proximity to handle 202. The open position of child seat 204 as defined herein includes the child seat 204 and back 206 expanded so as to extend distally and away from rear sidewall 201 to define the seat and back 206 for a child. Openings are typically defined in rear sidewall 201 for the legs of the child to extend proximally. The child seat 204 is constructed for the child to face proximally or in the direction of rear sidewall 201.

Shopping cart 200 is initially positioned in a stable position. As defined herein a stable position includes positioning shopping cart 200 at a fixed location. The stable position includes, for example, positioning movable shopping cart 200 such that shopping cart 200 will remain fixed at the desired location. Shopping, cart 200 in the stable position will not unduly move before, during or after the positioning onto and connection of infant carrier 1 to shopping cart 200 using safety apparatus 10. The stable position preferably includes positioning shopping cart 200 on an approximately level surface such that shopping cart 200 is at rest and not moving. Alternatively, if available, shopping cart 200 may have a brake to lock one or more wheels or one or more wheels of shopping cart 200 can be chocked or blocked so as to prevent undesirable, rolling. The stable position can also include, as another alternative or in, addition to the above, positioning one hand on infant carrier 1 in a first position with infant carrier 1 resting on and between rear sidewall 201 and foldable seat 204 back 206 in the open position so as to maintain infant carrier 1 and shopping cart 200 in the stable position while using, safety apparatus 10 to connect infant carrier 1 to shopping cart 200.

It is also understood that as described herein a user applies the method of using safety apparatus 10 to connect infant carrier 1 to shopping cart 200. In this method, safety apparatus 10 is constructed to include the single-handed positioning of shopping cart 200 in the stable position and the singled-handed connection of safety apparatus 10 between infant carrier 1 and shopping cart 200. A single-handed ability to connect safety apparatus 10 between infant carrier 1 and shopping cart 200 is particularly advantages because the need to retain infant carrier 1 and shopping cart 200 in the stable position. Alternatively, if the stable position can be achieved and retained without the use of the single hand, the user can employ both hands to connect infant carrier 1 to shopping cart 200 using safety apparatus 10.

Infant carrier 1 is preferably positioned on child seat 204 of shopping cart 200. Infant carrier 1 shell 3 seat 3A is preferably positioned in direct contact with rear sidewall 201 of shopping cart 200 and the back 3B is preferably positioned in direct contact with the top edge of back 206 of child seat 204. By positioning infant carrier 1 as described above in an approximately supine position, shell 3 extends into seat 204 and maintains a lower center of gravity of infant carrier 1 into child seat 204. This location of infant carrier 1 in child seat 204 facilitates the secure positioning of shell 3 in shopping cart 200 using safety apparatus 10. Further, this location of infant carrier 1 in child seat 204 facilitates safety apparatus 10 putting at least some downward tension between infant carrier 1 on child seat 204 and shopping cart 200.

As stated above, infant carrier apparatus 1 is positioned on safety seat 204 of shopping cart 200. Handle 5 of infant carrier 1 is shown in an approximately vertical position. The approximately vertical position aids in the securing of a fixed connection between first bar 12 on handle 5 and second bar 14 and third bar 16 that connect to shopping cart 200. When infant carrier 1 is positioned on seat 204 as defined herein, a first side of shopping cart 200 that includes a first lateral sidewall of basket 210 is adjacent the first side of infant carrier 1. Similarly, when infant carrier 1 is positioned on seat 204 as defined herein, a second side of shopping cart 200 that includes a second lateral sidewall of basket 210 is adjacent the second side of infant carrier 1.

Safety apparatus 10 in the first embodiment preferably includes flexible bars 12, 14 and 16. First bar 12 has a relatively short length that is suitable for connecting tightly around handle 5 of infant carrier 1. First bar 12 is preferably connected around handle 5 in proximity to shell 3 on a first side of infant carrier 1. Fastener 22 secures the first end portion 18 and second end portion 20 together around handle 5. The length of first bar 12 is preferably adjusted using fastener 22 and/or adjustment device 28 either before or after fastener 22 is secured. First bar 12 has a first position of first fastener 22 that includes first connector 24 and second connector 26 unconnected and a second position of fastener 22 that includes first connector 24 and second connector 26 fastened together around handle 5 to define the second position of first bar 12. Fastener 22 and/or adjustment device 28 can be used to adjust the length of first bar 12 using a single hand or two hands. The adjustment device 28 and/or fastener 22 are child resistant and/or child proof devices that can be locked to secure the adjusted length of first bar 12.

First bar 12 provides a secure childproof connection around handle 5. First bar 12 can be connected to handle 5 prior to or after the positioning of infant carrier 1 on shopping cart 200. When first bar 12 is connected around handle 5 prior to the positioning of infant carrier 1 on shopping cart 200, safety apparatus 10 second bar 14 and third bar 14 are preferably tucked into infant carrier 1 or temporarily wrapped around handle 5 so as to preclude their dangling from infant carrier 1. Similarly, the second bars 12 and third bars 14 of the two safety apparatuses 10 can be connected to the shopping cart 200 first and then infant carrier 1 positioned onto seat 204. The first bars 12 of each safety apparatus 10 is then connected with the corresponding side of infant carrier 1 handle 5 in, proximity to the shell 3 and adjusted in length as required to create a taught connection of the safety apparatuses 10 between infant carrier 1 and shopping cart 200.

Second bar 14 is extended from its connection with first bar 12 around handle 5 to fasten connector 36 to shopping cart 200. Second bar 14 connector 36 is preferably connected to at least one wire 208 on a first lateral sidewall of shopping basket 210. Second bar 14 connector 36 is preferably connected to at least one wire 208 of the first lateral sidewall of shopping basket 210 in proximity to rear sidewall 201. Second bar 14 connector 36 is also preferably connected proximal to the location of handle 5 of infant carrier 1 on seat 204 of shopping cart 200 to at least one wire 208 of basket 210.

Gate 44 of hook 38 is biased to the closed position with gate 44 in apposition or direct contact with hook 38 distal end 45. Gate 44 is preferably structured such that when gate 44 is forced against at least one wire 208, gate 44 flexes and wire 208 passes by gate 44 and into hook 38. Hooks 38 have the structural dimensions to receive wires 208 as defined herein past bias elements or gates 44 and into the interior of hooks 38. Once at least one wire 208 has passed gate 44, the bias of gate 44 then returns gate 44 to the closed position and captures the portion of the at least one wire 208 in hook 38. By securing connector 36 to a junction of two or more wires 208, connector 36 can fix the position of connector 36 on shopping cart 200. The urging or bias of gate 44 can further include a mating interface with distal end portion 42 of hook 38. As desired, a secondary locking mechanism can secure gate 44 in the closed position.

Second bar 14 can be adjusted in length using adjustment device 46. The adjustment of second bar 14 can be done before or after connector 36 is attached to the at least one wire 208. Connector 36 is sized and dimensioned to receive a portion of shopping cart 200 that is preferably at least one wire 208, but can other portions that are preferably on the first side of the shopping cart 200 adjacent the first side of the infant carrier 1. As per above, wires 38 include relatively thin metal wires as well as polymer strips, bands, panels or walls that define apertures 212. Connector 36 can also include two or more hooks 38 or have removable and replaceable connectors 36 with hooks 38. Connectors 36 and/or hooks 38 can include varying overall sizes, with varying sizes of gaps and gates for the connection of second bar 14 and/or third bar 16 to any known structure of shopping cart 200 wall.

Third bar 16 is extended from its connection with first bar 12 around handle 5 to fasten connector 36 to shopping cart 200. Third bar 16 connector 36 is preferably connected to at least one wire 208 on a first lateral sidewall of shopping basket 210. Third bar 14 connector 36 is preferably connected to at least one wire 208 of the first lateral sidewall of shopping basket 210 distal to the location of handle 5 of infant carrier 1 on seat 204 of shopping cart 200 to at least one wire 208 of basket 210.

The preferred method of connecting of third bar 16 connector 36 to the at least one wire 208 is the same as described for second bar 14 above. Third bar 16 can be adjusted in length so as to make the length of second bar 14 and third bar 16 tight and under tension between the connection of first bar 12 around handle 5 of infant carrier 1 and shopping cart 200. The adjustment in length of third bar 16 can include using adjustment device 56, as required, before or after connector 36 is connected to shopping cart 200 to provide an adequate degree of tension between shopping cart 200 and handle 5 of infant carrier 1.

The above is repeated for a second safety apparatus 10 by fastening first bar 12 on handle 5 in, proximity to shell 3 on the opposing second side of the infant carrier 1. As described above, the second safety apparatus 10 is used for connecting and placing tension between the second side of infant carrier 1 and the adjacent second lateral side of shopping cart 200.

The first and second safety apparatus 10 are structured to secure infant carrier 1 downward into and laterally on shopping cart 200. The second safety apparatus 10 second bar 14 and third bar 16 connectors 36 preferably connect first bar 12 fastened around handle 5 on the second side of infant carrier 1 to the adjacent wires 208 of the second side wall of basket 210 of shopping cart 200. The combination connection and tension provided by infant safety apparatus 10 first bar around the securely connects infant carrier 1 to the child seat 204 of shopping cart 200. Safety apparatus 10 provides an adequate degree of tension between shopping cart 200 and handle 5 of infant carrier 1 to secure infant carrier apparatus 1 in position on shopping cart 200.

Throughout the time of connecting safety apparatus 10 between infant carrier 1 and shopping cart 10, a single hand can be used to hold infant carrier 1 and shopping cart 200 in the stable position and the opposing hand to attaching connectors 36 of second bar 14 and third bar 16 to shopping cart 200. As stated above, also, the infant can be placed in infant carrier 1 before, during or after the securing of infant carrier 1 on shopping cart 200.

Infant carrier 1 can be disconnected from shopping cart 200 by reversing the above method for connecting infant carrier 1 to shopping cart 200. This includes maintaining shopping cart 200 and infant carrier 1 in the stable position and disconnecting connectors 36 of second bar 14 and third bar 16 from shopping cart 200. As noted earlier, first bar 12 can optionally remain connected to handle 5 of infant carrier 1.

As shown in FIGS. 1, 4, 6 and 7, the safety apparatus 10 can further include providing multiple sets of four connectors 49 with each set of four connectors including the same structure of hook 38 structure. Each set of four connectors 49 with the same structure of hook′38 is configured for attachment to connectors 36 of second bar 14 and third bar 16 of the two different safety apparatuses 10 required for securing infant carrier 1 on shopping cart 200 as described above. This configuration of safety apparatus 10 enables the selection and testing on shopping cart 200 of one or more structures of hooks 38 of the different sets of four connectors 49 prior to the attachment of connectors 49 with connectors 36. Safety apparatus 10 provides this testing ability for different hook 38 structures because of the variety of different structures for wire 208 and/or ornamental designs of the sidewalls of basket 210 that defines the plurality of apertures 212 and other structures of shopping carts 200.

As shown, three exemplary structures of hooks 38 include from left to right in FIG. 7, a spring clip, a C clip or carabiner clip and a bolt snap clip. Each structure of hook 38 has advantages for applications with different shopping carts 200. As one example, the spring clip and C clip structures of hook 38 can define larger openings 43, gates 44, depth between opening 43 and hook distal end portion 42 and length between proximal end portion 40 and distal end portion 42 of hook 38. The snap clip and C clip structures of hook 38 are particularly advantageous for accommodating and securing around what are relatively thin, but wide ribbon or band structures that are commonly used for shopping cart 200 sidewalls 210.

C clip structures of hooks 38 as described herein have biased gates 44 that enable the passing, receiving and securing of what are often wide and thin band structures for polymer sidewalls of baskets 210. The bias of gate 44 enables the connection of hook 38 to shopping cart 200 as described above. The loop bracket 41 of the C clip structure of connector 38 also advantageously allows the C clip hook 38 to be slid through bracket 41 which aid in the inserting hook 38 distal end portion 42 into apertures 212 for the passing of the portion of lateral sidewall of basket 210 into hook 38 and the closing of gate 44, for example.

Other structures of hooks 38 can have a different connection process with shopping cart 200. For example, the structures of hook 38 can include a gate 44 that requires manual displacement to open hook 38 as shown by the bolt snap clip structure of hook 38. The bolt snap clip is biased to the closed position and requires the manual displacement, of gate 44 to define opening 43. In one preferred structure of hook 38, gate 44 includes a tab that facilitates the manual moving of gate 44 from a closed position with gate 44 in direct contact with distal end 45 of distal end portion 42 of hook 38 to define an open position. Gate 44 is preferably opened by moving the tab proximally to retract the bolt that is gate 44 into the shaft of proximal end portion 40 of hook 38. The amount of the retraction of gate 44 in this structure of hook 38 can vary from a small opening to gate 44 being fully retracted into proximal end portion 40 so as to provide a maximum width of opening 43.

The bolt snap clip hook 38 can advantageously enable the attachment of this structure of hook 38 to shopping cart 200. The depiction of the bolt snap clip is idealized and can vary in dimensions to include the dimensions defined herein for opening 43, the depth between opening 43 and proximal end portion 40 and the length between distal end portion 42 and proximal end portion 40 of hook 38. The bolt snap clip hook 38 is, particularly advantageous for receiving one or more of wires 208 that are thin metal bars or rods and/or similar polymer structures that have ornament design arrangements of bars or beam shaped wires 208 that are portions of shopping cart 200. The at least one wire 208 retained by the bolt snap clip is easily released by the retraction of the bolt snap to the open position as described and movement of the clip from the at least one wire 208. The bolt snap clip structure of hook 38 provides a readily attachable and detachable type of connector 49 and/or connector 36.

Structures of hook 38 can also include configurations similar to the second embodiment first bar 12 that include a hinge that connects a first end portion and a second end portion of hook 38. The first end portion and second end portion preferably have arcuate approximately semicircular shapes that define a closed loop in a closed position. The first end portion is fixed relative to the proximal end portion 40 of hook 38. The second portion is movable relative to the first end portion and biased to the closed position. In the closed position of this configuration, the first end portion and second end portion have an overlapping relationship of a predetermined length. The second end portion includes a tab enables the moving of the second end portion to an open position of hook 38 to receive the portion of shopping cart 200. Releasing the tab on the second end portion urges the second end portion to the closed and overlapping position with the first end portion. This hook 38 is released by using the tab to move and open the second end portion from the first end portion. The hook 38 is then moved relative to the shopping cart for the release of safety apparatus 10.

The method of selecting a set of four connectors 49 each with the same structure of hook 38 from a plurality of sets of four connectors 49 can include connecting connectors 49 to shopping cart 200 prior to the positioning of infant carrier 1 on shopping cart 200. Alternatively, the set of connectors 49 with the same structure of hook 38 can be attached to connectors 36 of second bar 14 and third bar 16 of each safety apparatus 10 prior to the connection to shopping cart 200.

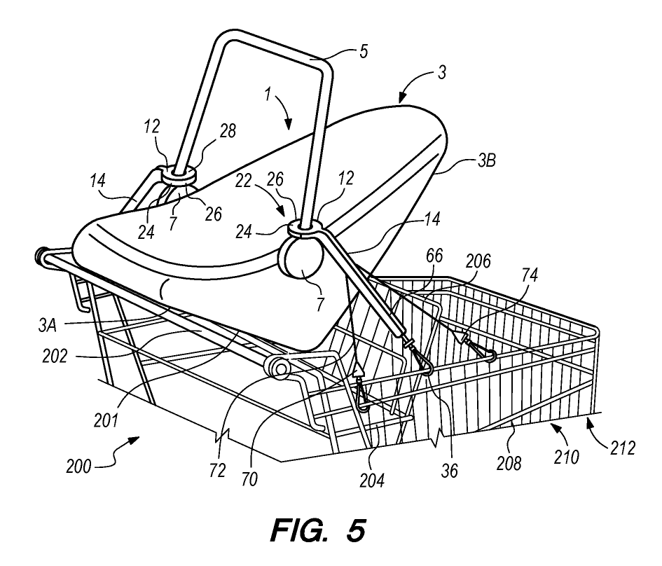

Referring now to FIGS. 2, 3, 5 and 6, in the second preferred embodiment of safety apparatus for an infant carrier 10, infant carrier 1 is positioned on shopping cart 200 as described above. First band or bar 12 first end portion 18 includes first connector 24. First bar 12 second end portion 20 includes second connector 26 that defines an aperture 27 that receives connector 24. First connector 24 includes a plurality of cantilevered extensions 29 that can be, such as for example, teeth, prongs or bayonets that are received into aperture 27. The loop defined by first bar 12 can accommodate the adjustment of the size of the loop of defined by first bar 12 around carrying handle 5 of infant carrier 1 by adjusting adjustment device 28. The adjustment device 28 can be a separate device from or a part of first connector 24 and/or second connector 26. As per the first embodiment, adjustment devices 28, 46 and 56 can include locking devices that securely fix the length of first bar 12, second bar 14 and third bar 16 respectively. First fastener 22 provides a secure, fixed and childproof connection for first bar 12 around handle 5. In this one preferred embodiment, for example, the disconnecting of fastener 22 requires the simultaneous compression on both side edges of fastener 22 to disengage the prongs 29 of first connector 24 from the aperture 27 of second connector 24 the relative movement of first end 24 from second connector 26.

First bar 12 is positioned around handle 5 in proximity to one of the two opposing connections of handle 5 to shell 3. In a first position, first fastener 22 first connector 24 and second connector 26 are unfastened. The unfastened or open first fastener 22 is positioned around handle 5. First bar 12 connected around handle 5 is preferably in continuous contact with handle 5. Once fastened around handle 5, first connector 24 and second connector 26 of fastener 22 define the second position or closed position of first bar 12.

First bar 12 is adjustable in length using the adjustable relationship between teeth 29 and aperture 27 of adjustment device 28. First bar 12 is a loop that can be selectively adjusted in length or diameter for a tight fit around handle 5. First bar 12 provides a secure, fixed and childproof connection around handle 5.

Continuing with the second embodiment, second bar 14 proximal end portion 30 preferably has a fixed connection to first bar 12. Second bar 14 includes first beam 60 and second beam 62. First beam 60 is structured to accommodate the movement of second beam 62. First beam 60 is preferably structured to accommodate the extending and retracting of second beam 62 along the axis-X. Second beam 62 includes a proximal end portion 66 that is slidably positioned relative to first beam 60 distal end portion 64. In the preferred embodiment, second beam 62 is slidably connected and adjustable in length relative to first beam 60. Second or distal end portion 32 of second bar 14 includes connector 36. Second bar 14 is adjusted in length through the movement of second beam 62 along the longitudinal axis-X. In this preferred embodiment of second bar 14, second beam 62 interfaces with a channel 67 defined in first beam 60. Second beam 62 can be a rigid or flexible beam.

Connector 36 in this preferred embodiment is located on or in proximity to second end portion 32 of second bar 14. Connector 36 is structured to make a secure connection to basket 210 of shopping cart 200 as described previously. Connector 36 is particularly structured to connect to at least one wire 208 that includes polymer structured shopping cart 200 baskets 210.

Secondary connectors 70 are connected to second bar 14. Secondary connectors 70 are preferably connected, on approximately opposing sides of second bar 14 and to or in proximity to distal end portion 64. Connectors 74 are similar to connectors 36 and are particularly structured to connect to wires 208.

The alignment of the first bar 12 in a first plane positions first bar 12 approximately perpendicular to the alignment of handle 5. Handle 5 is preferably positioned approximately vertical when body 3 is positioned in cart 200. First bar 12 is connected to handle 5 in close proximity to body 3 of infant carrier apparatus 1. Similarly, the alignment of second bar 14 between first bar 12 and second end portion 32 is approximated to, align connector 36 for a secure connection to wires 208 of shopping cart 200.

Connectors 36 for second bar 14 and third 16 are fastened to one of wires 208 by pushing the wire 208 against the bias element 44 and into hook 38 to secure connector 36 with shopping cart 200. Connector 36 is sized and dimensioned to receive wires 208 that include broad flat polymer strips past bias element 44 and into hook 38. Connector 36 can also include two or more hooks 38 or have removable and replaceable connectors 36 with hooks 38. Connectors 36 and/or hooks 38 of varying overall sizes with variations in the sizes of their gaps can have connections to second bar 14. Bar 14 can be adjusted in length as required using second beam 62 and adjustment device 68 before or after connector 36 is attached to one or more of wires 208. Second beam 62 can fixed at a desired length extending from first beam 60. Secondary connectors 70 are connected to wires 208 at an angle approximately perpendicular to that of second bar 14. Secondary connectors 70 provide additional lateral stability to second bar 14 by providing secondary points, of connection from second bar 14 to shopping cart 200.

Safety apparatus 10 adjustment device 68 provides an adequate degree of tension between shopping cart 200 and handle 5 of infant carrier 1 to secure infant carrier apparatus 1 in position on shopping cart 200. It is understood, for example, that connector 36 can connect directly to one or more wires 208 as well as other structures on shopping cart 200 such as handle 202. To further connectivity between connectors 36 and shopping cart 200, connectors 36 can include a flexible portion or extension similar to that of secondary connectors 70. In this embodiment, connectors 36 can extend through a gap 212 in the lattice of wires 208, around one or more wires 208, back through one of the gaps 212 such that connectors 36 fasten onto the flexible portion of connector 36.

In the preceding specification, the present disclosure has been described with reference to specific exemplary embodiments thereof. It will be evident, however, that various modifications, combinations and changes, may be made thereto without departing from the broader spirit and scope of the invention as set forth in the claims that follow. For example, while fastener 22 is described in terms a specific configuration of first connector 22 and second connector 24, it is understood that connectors 22 and 24 can have any structure that provides a child proof, safety connector with suitable load bearing qualities. While the present disclosure is described in terms of a series of embodiments, configurations and/or arrangements, the present disclosure can combine one or more novel features of the different embodiments. The specification and drawings are accordingly to be regarded in an illustrative manner rather than a restrictive sense.

What is claimed is:

1. A safety apparatus for an infant carrier, the safety apparatus adapted for connection between the infant carrier and a shopping cart, the safety apparatus comprises:
a first bar, the first bar includes a first end portion and an opposed second end portion, a fastener securely connects and disconnects the first end portion and second end portion, the first end portion includes a first connector and the second end portion includes a second connector, the first bar is a flexible strap, the first bar includes an adjustment device that adjusts the length of the first bar, when the connectors of the first bar are fastened the first bar defines a continuous loop;
a second bar, the second bar includes a first end portion and a second end portion, the first end portion is connected to the first bar and the second end portion is a free end, the second end portion includes a third connector, the third connector defines an opening, the third connector includes a gate that is biased to a closed position, the third connector adapted to receive a portion of a structure of a shopping cart, the length of the second bar is adjustable, the second bar is flexible;
a third bar, the third bar includes a first end portion and a second end portion, the first end portion is connected to the first bar and the second end portion is a free end that includes a fourth connector, the fourth connector defines an opening, the fourth connector includes a gate that is biased to a closed position, the fourth connector adapted to receive a portion of a structure of a shopping cart, the length of the third bar is adjustable, the third bar is flexible; and
the fastener of the first bar is adapted to connect around a handle of an infant carrier on a first side of the infant carrier and in proximity to a shell of the infant carrier, the third connector of the second bar and the fourth connector of the third bar are adapted to connect to the shopping cart, the third connector and the fourth connector define hooks, the hooks of the third connector and fourth connector define an opening and a gate, the gate is biased to a closed position that closes the opening of the hook, the length of the first bar, the length of the second bar and the length of the third bar are adjustable, the second bar and third bar are adapted to adjusted for a tight fit between the handle of the infant carrier and the shopping cart;
the first bar of a second safety apparatus for an infant carrier is adapted to connect around the handle of the infant carrier on a second side of the infant carrier in proximity to the shell of infant carrier, the second bar and the third bar adapted to connect the first bar of the second safety apparatus connected around the handle of the infant carrier to the shopping cart.

2. The safety apparatus of claim 1, wherein the third connector of the second bar and the fourth connector of the third, bar are hooks and the hooks of the first safety apparatus and the second safety apparatus are adapted to securely connect to shopping carts.

3. The safety apparatus of claim 1, wherein the third connector of the second bar and the fourth connector of the third bar include hooks, the hooks define an opening, the length of the opening is approximately one inch, the hook includes a gate that is biased to a closed position, and the hooks of the first safety apparatus and second safety apparatus are adapted to securely connect to the lateral sidewalls of the basket of the shopping carts, the lateral sidewalls of the shopping carts include wires that define apertures.

4. The safety apparatus of claim 1, wherein the second bar and the third bar are movable along the first bar and can be connected to the first bar at any location along the length of the first bar.

5. The safety apparatus of claim 1, wherein the adjustment mechanism for the length of the first bar includes a lock and the adjustment mechanism can be locked in position.

6. The safety apparatus of claim 5, wherein the adjustment mechanism of the second bar and third bar include a lock and the adjusted length of the second bar and third bar can be locked in position.

7. The safety apparatus of claim 1, wherein the third and fourth connectors include a secondary locking mechanism to secure the gate in position.

8. The safety apparatus of claim 1, wherein the third connector of the second bar and the fourth connector of the third bar include hooks, the hooks define an opening, the length of the opening of the hook is at least one inch, the hook includes a gate that is biased to a closed position, and the hooks of the first safety apparatus and second safety apparatus are adapted to securely connect to the polymer lateral sidewalls of the baskets of shopping carts, the polymer walls of the baskets of the shopping carts define apertures.

9. The safety apparatus of claim 1, wherein the third and fourth connectors include a hinged gate and the gate is biased to the closed position.

10. The safety apparatus of claim 1, wherein the third and fourth connectors include a sliding gate and the gate is biased to the closed position.

11. The safety apparatus of claim 1, wherein the second bar and the third bar are located between approximately thirty degrees and approximately 120 degrees apart on the first bar.

12. A method of connecting a safety apparatus for an infant carrier to a shopping cart, the method comprising the following steps:
providing an infant carrier, a shopping cart, a first safety apparatus for an infant carrier and a second safety apparatus for an infant carrier, the safety apparatus for an infant carrier comprising a first bar, a second bar and a third bar, the first bar includes a first end portion and an opposed second end portion, a fastener includes a first connector on the first end portion and a second connector on the second end portion, the connectors configured to fasten together and unfasten, the first bar includes an adjustment device that adjusts the length of the first bar, when the connectors of the first bar are fastened the first bar defines a continuous loop,
the second bar includes a first end portion and, a second end portion, the first end portion of the second bar is connected to the first bar and the second end portion, of the second bar is a free end that includes a third connector, the length of the second bar adjustable;
the third bar includes a first end portion and a second end portion, the first end portion of the third bar is connected to the first bar and the second end portion of the third bar is a free end that includes a fourth connector, the length of the third bar adjustable;
positioning the first bar of the first safety apparatus around a handle on a first side of the infant carrier in proximity to a body of the infant carrier and connecting the connectors of the first bar, adjusting the length of the first bar to secure a tight connection of the first bar to the handle, the first bar connected around the handle and in proximity to a first side of the body of the infant carrier;
positioning the shopping cart in a stable position;
positioning the infant carrier on the shopping cart, the infant carrier resting between a rear sidewall and a back of the foldable child seat;
fastening the third connector of the second bar of the first safety apparatus for an infant carrier to a shopping cart by connecting the third connector of the second bar of the first safety apparatus to a first side of the shopping cart, the third connector defines an opening, the third connector receiving and securely closing around a portion of the shopping cart between two apertures, adjusting the length of the second bar to secure a tight connection of the first safety apparatus for an infant carrier between the handle of the infant carrier and the shopping cart,
fastening the fourth, connector of the third bar of the first safety apparatus for an infant carrier to the shopping cart by connecting the fourth connector of the third bar to a first side of the shopping cart, the fourth connector defines an opening, the fourth connector receiving and securely closing around a portion of the shopping cart between two apertures, adjusting the length of the third bar to secure a tight connection of the first safety apparatus for an infant carrier between the handle of the infant carrier and the shopping cart;
connecting a second safety apparatus between the infant carrier and the shopping cart, the connecting of the second safety apparatus including positioning the first bar of the second safety apparatus around the handle on a second side of the infant carrier in proximity to the body of the infant carrier and connecting the connectors of the first bar, adjusting the length of the first bar to secure a tight connection of the first bar to the handle, the first bar connected around the handle and in proximity to a second side of the body of the infant carrier;
fastening the third connector of the second bar of the second safety apparatus to the shopping cart by connecting the third connector of the second bar to a second side of the shopping cart, the third connector defines an opening, the third connector receiving and securely closing around a portion of the shopping cart between two apertures, adjusting the length of the second bar to secure a tight connection of the second safety apparatus for an infant carrier between the handle of the infant carrier and the shopping cart,
fastening the fourth connector of the third bar of the second safety apparatus for an infant carrier to the shopping cart by connecting the fourth connector of the third bar to the second side of the shopping cart, the fourth connector defines an, opening, the fourth connector receiving and securely closing around a portion of the shopping cart between two apertures, adjusting the length of the third bar to secure a tight connection of the second safety apparatus between the infant carrier and the shopping cart, the first and second safety apparatus fixing the infant carrier in position on the shopping cart.

13. The method for a safety apparatus for an infant carrier of claim 12 wherein the connecting of the connectors of the first bar, second bar and third bar further includes locking a secondary locking mechanism.

14. The method for a safety apparatus for an infant carrier of claim 12 wherein the first bar, second bar and third bar are flexible bars.

15. The safety apparatus of claim 1, wherein the third connector of the second bar and the fourth connector of the third bar each connect with a plurality of fifth connectors, each of the fifth connectors include the fifth connector on one end and at least one hook on the opposing end, the hooks of the at least two fifth connectors adapted to connect to different shopping cart structures, selecting a hook connected to the fifth connector from the plurality of fifth connectors for the third connector and the fourth connector.

16. The safety apparatus of claim 1, wherein the third connector of the second bar and the fourth connector of the third bar include at least two different hooks, the different hooks adapted to connect to different shopping cart structures.

17. The safety apparatus of claim 1, wherein the first bar of the safety apparatus is adapted, to connect to the handle on the first side of the infant carrier and the second bar and third bar of the safety apparatus are adapted to connect to a first side of the of the shopping cart, the second safety apparatus is adapted to connect to the handle on the second side of the infant carrier, the second side of the shopping cart adjacent to the second side of the infant carrier and the second bar and third bar of the second safety apparatus are adapted to connect to a second side of the shopping cart, the second side of the shopping cart adjacent to the second side of the infant carrier.

18. The method for a safety apparatus for an infant carrier of claim 12, wherein the step of providing further includes a plurality of fifth connectors, third connector of the second bar and the fourth connector of the third bar each connect with each of connector of the plurality of fifth connectors, each of the fifth connectors include the fifth connector on one end and at least one hook on the opposing end, the hooks of the plurality of fifth connectors connect to shopping carts, selecting a fifth connector and hook from the plurality of fifth connectors for the third connector and the fourth connector for connecting to the shopping cart.

19. The method for a safety apparatus for an infant carrier of claim 12 wherein the third connector of the second bar and the fourth connector of the third bar include hooks, the hooks define an opening, the length of the opening of the hook is at least one inch, the hook includes a gate that is biased to a closed position, and the hooks of the first safety apparatus and second safety apparatus configured for securely connecting to the polymer walls of the shopping carts, the polymer walls of the shopping carts define apertures.

20. The method for a safety apparatus for an infant carrier of claim 12 wherein the shopping cart and infant carrier are in a stable position during the installation of the safety apparatus between the infant carrier and the shopping cart.
